(19) United States
(12) Patent Application Publication
(10) Pub. No.: US 2007/0293289 A1
(43) Pub. Date: Dec. 20, 2007

(54) Methods and systems for realistically simulating human sports activities

(76) Inventor: Michael R. Loeb, New York, NY (US)

Correspondence Address: JLB CONSULTING, INC.;c/o INTELLEVATE, P.O. BOX 52050, MINNEAPOLIS, MN, 55402, US

(21) Appl. No.: 11/190,795

(22) Filed: Jul. 27, 2005

(51) Int. Cl. A63F 13/00

(52) U.S. Cl. 463/4

(57) ABSTRACT

There are provided methods (200) and systems (100) for simulating sports activities. Historical data is aggregated to develop realistic, simulated, fictional players and teams (206, 208). The aggregation of data is sufficient to avoid any discrete identification of a simulated player, team, league or other participant with a real-life equivalent. The historical data collected is sufficient in quantity and type that simulated sports events can be realistically performed in substantially unlimited scope and quantity. Degrees of randomness may be introduced (510) to provide excitement and unpredictability. Non-random variations to the historically based activities can be made (512) so as to alter the fundamental nature of a player, team or league. Outcomes of the simulation can be generated substantially indefinitely to provide long-term entertainment, for example full seasons and multiple seasons/years of sports activities. The simulated sports activities of the present invention can be presented to fans in lieu of live sports events (522). Mediums of presentation (600) can include, for example, live video displays, television transmissions, radio transmissions and real-time display to stadium fans.

### FIELD OF THE INVENTION

This invention relates generally to simulations of physical events and more particularly to methods and systems for realistically simulating human activities such as sports activities.

### BACKGROUND OF THE INVENTION

Before the advent of licensed broadcast deals and huge radio and television audiences, the majority of revenue generated by sports activities came from ticket sales. While athletes made reasonable salaries, the costs of team ownership were generally bounded by the conventional costs of salaries, facilities, advertising, and other normal business costs. Ticket sales covered costs with profits often available to the team owners.

The development of live, broadcast sports activities elevated athletes to the status of national heroes. While a typical physical stadium holds only thousands of seats, broadcast sports events provide one of the largest sources of entertainment to one of the largest audiences in existence today. The United States Super Bowl football game, for example, draws over 100 million viewers while European World Cup soccer games boast over a billion spectators.

Along with live broadcasts have come high costs. This is particularly true of team sports such as baseball, football, basketball, car racing and soccer. Considering athlete salaries alone, the ‘star’ status of athletes has driven salaries to extraordinarily high levels. The New York Yankees baseball team has a reported salary cost of over $200,000,000.00 for the 2005 year, while Derek Jeter alone has a contract salary of over $19,000,000.00 for that same year. The Miami Dolphins football team had an estimated salary cost of over $93,000,000 for the year 2004, while for basketball the Boston Celtics have an estimated payroll of over $53,000,000.00 for the 2004-2005 season divided among just 12 players.

It is not just salary costs that have increased and it is not just team owners that are shouldering the increased costs. Advertising costs for a Super Bowl television advertisement can at times exceed $2,000,000.00 per 30-second spot. ESPN is estimated to spend over a billion dollars per year for licensing rights to broadcast sports events. These increased costs result in a ‘trickle down’ effect to fans. Ticket costs have risen astronomically, with season tickets often costing tens of thousands of dollars per season for prime seats. Tickets to particularly desirable events such as playoffs, Super Bowls, etc. may, for practical purposes, be unaffordable by or even unavailable to the average fan.

In contrast to the past; ticket revenues today come nowhere near covering the increased costs associated with owning a sports team. In fact, the present inventors estimate that ticket sales constitute less than 10% of team sports revenue, with the balance coming largely from broadcast licensing revenue. Even with the significant revenues in direct and ancillary sales resulting from the larger broadcast audiences, the extraordinarily high costs of live broadcasts are posing significant financial burdens and challenges for all parties; owners, fans, broadcasters and others.

One dilemma thus existing in sports as a business today is that broadcast of live sports performances, due in significant part to license rights fees, are much more expensive to provide at every turn, thus eating into profitability even as gross revenues increase. This is exacerbated by the trend that most of the revenue today comes from “other than attendance” revenue—while costs are still “live-event concentrated,” placing costs and revenues out of alignment. Moreover, as professional sports generates more and more revenues, players' salaries go up and up.

In addition to financial challenges, sports team owners as well as broadcasters and others in the sports industry are facing other serious challenges. Consider, for example, labor problems. United States baseball has been fraught with charges involving drug use by athletes. The 2004-2005 United States professional hockey season, that is the National Hockey League (NHL), was cancelled due to an inability of owners and players to resolve contractual disagreements. European soccer matches are plagued with uncontrollable violence, some of which have resulted in the death of fans. Sports icons are regularly arrested for criminal activities and held to public scrutiny and ridicule.

Despite all of the challenges associated with live sports activities today, they have become an integral part of life and national culture. Baseball is known as “America's Game.” Europe has significant cultural ties to soccer, as does Canada to ice hockey. Every country and culture has a historical tie to at least one significant sports activity. The Olympics has become an international focus for showcasing professional athletes as well as identifying the best amateur athletes in the world.

Sports activities are sufficiently interesting and entertaining that, in addition to their love of live activities, some small but regular group of fans engage in various gaming activities in addition to and/or in lieu of live sports events. Well known in the art are sports games including: strategic board games, mechanical board games with moving components, video and computer sports games and even various fantasy and ‘rotisserie’ type sports activities. While satisfying some demand for sports-type entertainment, today's games are not intended to and in fact do not substitute for live sports events.

The present inventor believes that today's sports fans would embrace life-like sports simulations, for example displayed in stadiums, broadcast on TV or webcast over the Internet, in lieu of actual live sports events. To be successful, however, the present inventor believes that such simulations would have to be virtually indistinguishable from live events. In fact, it is believed that an appropriately life-like simulation would not only satisfy fans, but also make profitable again the many ancillary businesses associated with sports entertainment; broadcasting and licensed products to name just a few. The present inventor believes, however, that no such suitable simulation for live sports yet exists.

With the advent of inexpensive, powerful computing capabilities, there have been developed inventions to simulate sports activities on a limited basis for gaming purposes. U.S. Pat. No. 6,292,706 to Birch et al., titled: Simulated Baseball Game, shows a method of simulating a baseball game based on the processing of actual historical player and actual team data.

The present inventor believes, however, that the Birch et al. system lacks in many respects. Principally, the Birch et al. system uses live player and/or team historical data to simulate corresponding player and team behavior in a ‘person-for-person,’ ‘situation-for-situation’ and ‘game-for-game’ type format. That is, a player's historical performance, combined with other player's historical performances, are generally used to simulate the outcome of each interaction and outcome within a single game. Birch et al. makes limited use of aggregated team player data when single player data is unavailable and then uses that data to simulate the performance of an actual or “name” player.

The Birch et al. patent bases its simulation on “name” players and teams. The present inventors believe that for a simulation to successfully replace live activities, it cannot be based upon identifiable “name” players and teams. Modeling a simulation upon an identifiable person or team will typically require licensing payments to those players and teams. See, for example, “A Battle Breaks Out Over Sports Rights in Videogame World,” by Wingfield, N., the Wall Street Journal Online, Jul. 11, 2005, wherein Electronic Arts, the video game producer, recently agreed to pay ESPN $800,000,000 to license the ESPN brand name for its line of sports video games. A famous player or team will not allow its trademarks or likenesses to be used without licensing payments, thus raising the specter of the financial challenges discussed above. Further, the Birch et al. system shows basically the simulation of a single game to completion. This, of course, is insufficient to entertain fans for any significant period of time.

Further, Birch et al. suffers significantly from providing only a game, requiring the active participation of the players. This is in stark contrast to actual sports events today, which are ‘pushed’ or broadcast to passive viewers. As mentioned above, the present inventor believes that the value of video games is recognized only by players who wish to actively participate in their entertainment. This is believed to be an audience that is i) significantly smaller than those of live sports broadcasts, and ii) composed of different demographics than those who watch live sports broadcasts. In short, the present inventor believes that a game requiring participation by a player is at best an ancillary activity to actual sports events and is not, and will never become, a suitable substitute for such events. It is believed that these, and other short-comings of Birch et al. make Birch et al. insufficient as a permanent, long-term substitution for live action sports.

In sum, live sports activities are a major source of entertainment on a worldwide basis. Today, however, they suffer many financial, labor, and other challenges. Some games and simulations are known which provide a relatively smaller group of interested players relatively limited, short-term enjoyment as substitutes for live-action sports. However, to the best of the present inventor's knowledge, no simulations are as yet known which are sufficient to substitute for live sports activities on a regular, long-term basis.

### SUMMARY OF THE INVENTION

The present inventors have developed methods and systems for simulating sports activities which they believe will suffice to replace actual, live sports on a regular, long-term basis.

In accordance with one embodiment of the invention, there are provided methods and systems for simulating a sports activity on a computer, an exemplary method comprising: collecting historical data relating to a sports activity; generating, by processing the historical data, simulated player data for simulating fictional players of the sports activity; generating, by processing the historical data, simulated play data for simulating sports plays in the sports activity including the fictional players; generating, using the simulated player data and the simulated play data, a human-interpretable simulation of the fictional players performing the sports plays; and outputting the human-interpretable simulation for consumption by fans.

In accordance with another embodiment of the invention, there are provided methods and systems for simulating a sports activity, a method comprising: selecting a team sports activity; collecting historical data for the team sports activity; generating, using the historical data, a plurality of fictional teams each comprising a plurality of fictional players; generating, using the historical data, a history for each of the fictional teams and fictional players; and generating, using the historical data, at least one season of games amongst the fictional teams.

In accordance with another embodiment of the invention, there are provided methods and systems for facilitating legalized gambling activities, a method comprising: selecting a team sports activity; collecting historical data for the team sports activity; generating, using the historical data, a plurality of fictional teams each comprising a plurality of fictional players; generating, using the historical data, a history for each of the fictional teams and fictional players; generating, using the historical data, at least one season of games amongst the fictional teams; receiving a certification that the generated games meets the legal requirements for betting in at least one legal jurisdiction; and broadcasting the generated games for betting by fans.

In accordance with another embodiment of the invention, there are provided methods and systems for generating cost-effective sports events, a method comprising: selecting a team sports activity; collecting historical data for the team sports activity; generating, based upon the historical data, a plurality of entirely fictional players, each having a personal fictional history; generating, based upon the historical data, a plurality of fictional teams each comprising selected ones of the fictional players, each of the teams having a team fictional history; and generating, using the fictional teams with fictional players, multiple seasons of games of the team sports activity; whereby the use of the historical data results in realistic games without obligating the payment of license fees to real-life parties.

In accordance with another embodiment of the invention, there are provided methods and systems for simulating a sports activity, a method comprising: selecting a sports activity; collecting historical data for the sports activity including historical data for players of the sports activity and historical data for equipment used in the sports activity; generating, using the historical data, a plurality of fictional players each assigned at least one piece of fictional equipment; and simulating, using the fictional payers and fictional equipment, the sports activity.

### BRIEF DESCRIPTION OF THE DRAWING FIGURES

These and other objects, features and advantages of the invention will be apparent from the Detailed Description of the Invention when considered in conjunction with the drawing Figures, in which:

FIG. 1 is a block diagram of a system in accordance with the present invention;

FIG. 2 is a flow chart showing a process for simulating sports characters and events in accordance with the present invention;

FIG. 3 is a flow chart illustrating the process of collecting historical sports event data in accordance with FIG. 1;

FIG. 4 is a flow chart illustrating the process of generating fictional sports characters and groups in accordance with FIG. 1;

FIG. 5 is a flow chart illustrating the process of generating simulated sports activities in accordance with FIG. 1; and

FIG. 6 is a flow chart illustrating the process of outputting the simulated sports activities in accordance with FIG. 1.

### DETAILED DESCRIPTION OF THE INVENTION

The present inventors have developed methods and systems for simulating sports activities which they believe will suffice to replace actual, live sports on a regular, long-term basis. In accordance with the present invention, historical data is aggregated and processed to develop realistic, simulated, yet fictional activities. Wholly fictional players, player histories, teams, team histories, coaches, leagues, games, seasons, etc. are created for the viewing entertainment of fans (in addition, team logos, mascots, stadium, etc. are also be simulated). Using the present invention, these entirely fictional players and events can have realistic histories and be developed indefinitely into the future. The invention enables the creation of enduring, realistic characters and groups without the requirement of license fees to live parties. Using the simulated players, teams, etc., simulated games can be generated, or ‘played,’ and broadcast in real-time with the simulation over a variety of media, including TV, internet, radio, etc.

The aggregation and processing of historical data is sufficient to avoid any discrete identification of a simulated player, team, league or other participant with a real- life equivalent. The historical data collected is sufficient in quantity and type that, when combined with the methods and systems provided by the present invention, simulated sports events can be realistically performed in substantially unlimited scope and quantity. As described above, entirely fictional players, teams and leagues can be developed, with both historical records and ongoing play for unlimited numbers of future seasons.

Where appropriate, in accordance with a feature of the present invention, degrees of randomness may be introduced to provide excitement and unpredictability. Further where appropriate, non-random variations to the historically based activities can be made so as to alter the fundamental nature of a player, team or league. Outcomes of the simulation can be generated substantially indefinitely to provide long-term entertainment, for example full seasons and multiple seasons/years of sports activities. In accordance with the present invention, the activities generated using the collection and processing of the historical data can be broadcast ‘live,’ that is as it is simulated, so that the events unfold before viewer's eyes as with live broadcast sports events.

When combined with readily known and available graphical simulations, displays, and broadcast capabilities, the simulated sports activities of the present invention can thus be presented to fans in lieu of live sports events. Mediums of presentation can include, for example, live video displays, television transmissions, radio transmissions and real-time display to stadium fans. In accordance with an advantage of the present invention, the present inventor theorizes that the simulations will be sufficiently realistic that they can form the basis for live sports betting, for example of the type supported by Nevada Sports Books.

For purposes of illustration, the present invention is described herein substantially with respect to the sport of baseball. It will be understood, and numerous details will be provided to show, that the invention is not limited to any single sport. It is generally applicable to all sports which may be simulated through the collection and processing of historical data, including the introduction of random and non-random variations. Exemplary sports within the scope of the present invention include: baseball, football, soccer, hockey, auto racing, and others as will now be apparent to the reader.

As used herein, descriptive terms such as “for example” and “include” or “including” are not limiting unless specifically identified as such.

Fans are referred to herein variously as fans, viewers, listeners and other obvious designators, depending in part on how they receive and enjoy the simulated sports content.

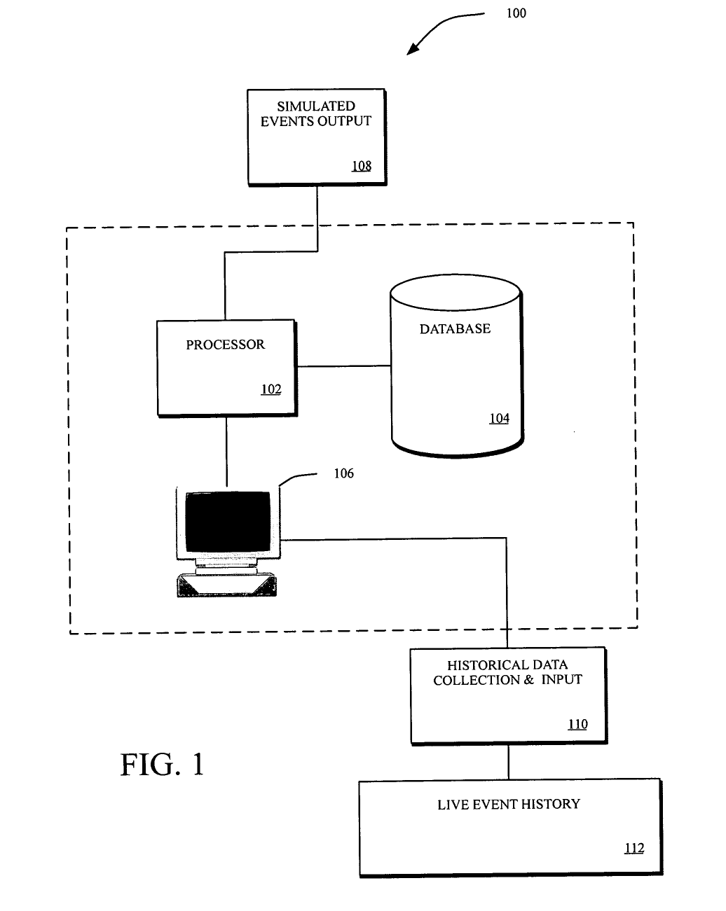

With reference now to FIG. 1, there is shown a system 100 for simulating human activities such as sports activities in accordance with an embodiment of the present invention. In the illustrated embodiment, system 100 includes a processor 102 connected to a database 104, a user input-output device 106 and a simulated events output device 108 for outputting simulated activities in accordance with the description herein below.

Processor 102 may comprise any conventional processor running a conventional software operating system, for example an Intel® processor running a Microsoft® Windows®-based operating system. Database 104 may comprise any conventional assortment of storage, for example an appropriate combination of semiconductor, magnetic and optical storage. Input output device 106 may comprise any appropriate user interface, for example a conventional terminal and keyboard. Output device 108 may comprise any suitable graphical display, broadcast, transmission or other device sufficient to output the simulated sports events in the manner described herein below.

While system 100 has been shown and described as a relatively simple, centralized system, it will be appreciated that the invention is not thus limited. The components may vary, the processor for example comprising one or more combinations of desktop, server and mainframe computing devices running one or more operating systems. The system may comprise one or multiple centralized and/or decentralized components performing the various, described functions and configured in one or more of numerous configurations as are well known to the reader.

Continuing with reference to FIG. 1, there is shown diagrammatically, for purposes of explanation, the collection and input into system 100 of historical data 110 based upon live event history 112, for processing and output of simulations at 108. These processes and systems are described in detail herein below.

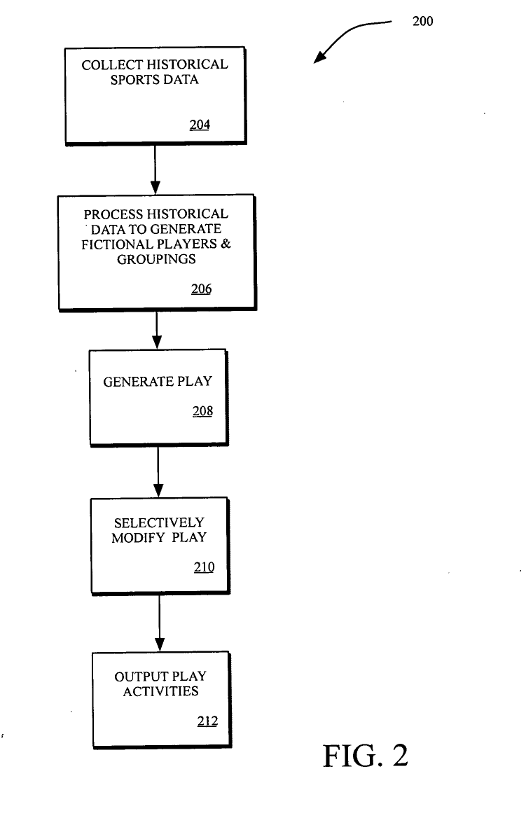

With reference now to FIG. 2, there is shown a process 200 for generating and outputting simulated human activities such as sports events. In accordance with this high-level overview of the invention, historical sports data is collected (step 204). The historical data it is processed to generate fictional players and, as appropriate, player groupings (step 206) such as teams. The historical data is further used to generate sports play (step 208).

In accordance with a key feature of the present invention, while based upon historical data, the simulated, or virtual, characters and players of the present invention represent entirely fictional characters. As will be described in detail herein below, players created in accordance with the present invention constitute an aggregation of collected, processed, historical data. While the players may be named and may have lengthy historical and future “careers,” they are purely fictional. Similarly fictional teams, leagues, coaches, umpires and other associated persons and groupings may be created with fictional histories and futures. Thus, expensive licenses are not required of real-life players. Entirely new players, groupings and associated persons may be created, developed, used and terminated in accordance with the needs of the business and with no ties or relations to real life people. In accordance with a significant advantage of the present invention, the use of purely fictional persons and groupings will decrease the costs of and increase the profits associated with the simulated sports provided by the present invention.

In accordance with the present invention, selective modifications can be made to the simulated events (step 210). As is described in detail below, these modifications may be random in nature, contributing to unpredictable play. The modifications may further be non-random in nature, where by to affect the fundamental nature of the activity in a desirable manner. As described in further detail below, modifications may be applied to the historical data before it is processed to simulate fictional players and activities, or applied to the simulated players and activities after they are generated using the historical data.

The simulated, selectively modified events are output (step 212) for consumption by fans. In accordance with a described embodiment of the present invention, the output typically occurs in real time over different periods of time. That is, in one embodiment of the invention, the output is generated in real time as it is simulated, for viewing, listening to, or other consumption by fans. The output may be generated for consumption in a variety of different media formats. Play may be simulated over any desired period of time, for example for a single game or a multi-year competition.

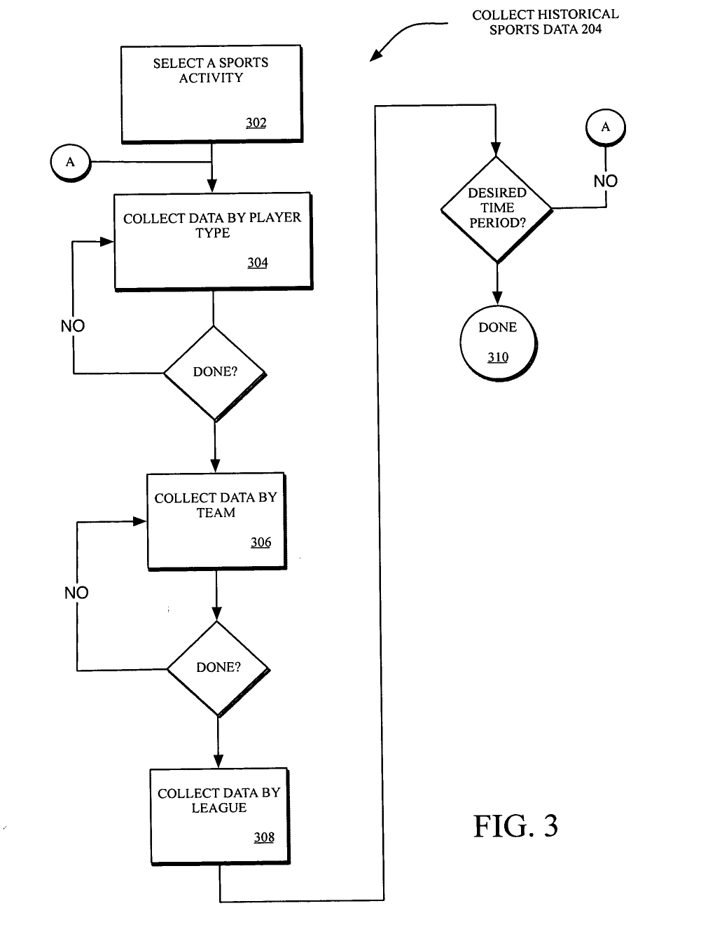

With reference now to FIG. 3, there are shown the details of process 204 for collecting historical sports data. Initially there is selected a sports activity to be simulated (step 302); baseball, as described herein. Within the selected sports activity historical data is collected by player type (step 304). Similarly, data is collected by grouping, that is team (step 306) and by league (step 308) over the desired period of time to completion (step 310).

It will be understood that this historical data is used only as a base to generate realistic future play. As noted here above, a significant feature of the present invention is that the players, teams, leagues and other elements of the sports activity, while developed based upon realistic historical data, comprise purely fictional characters and groupings. This provides significant advantages, including the ability to avoid significant licensing fees as well as the ability to flexibly establish players, teams, leagues and other elements as deemed necessary to facilitate the business.

In some embodiments of the invention, for example the simulation of automobile racing, equipment such as automobiles plays a significant part in the sports activity. In such circumstances, historical data may be collected on: i) the equipment itself, ii) the equipment as used by different operators, and iii) any other information relevant to the performance of the equipment. The historical equipment data is used to generate fictional equipment in a manner similar to that described with respect to players and teams. In a manner analogous to players, the fictional equipment may be provided fictional histories and futures. The equipment may be named, used by an operator(s), modified or otherwise used in the inventive simulation(s) described herein.

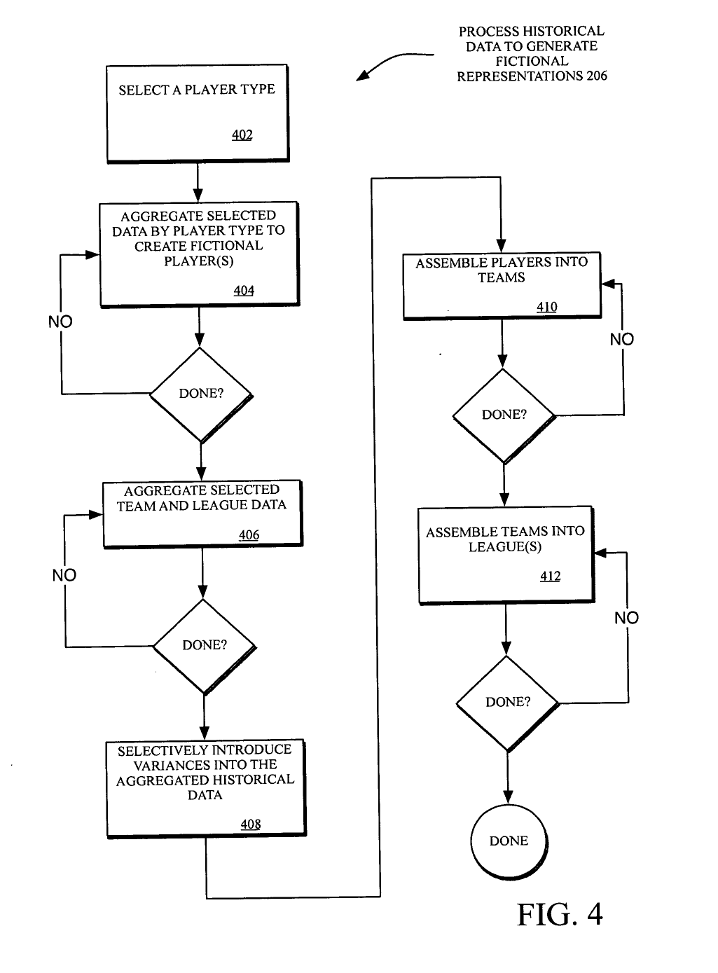

With reference now to FIG. 4, the details of process 206 for processing historical data to generate fictional representations are shown. In accordance with the invention, a player type is selected for creation of a fictional player (step 402), for example a baseball pitcher. Historical data is then aggregated in accordance with the selected type and quantity desired for the simulation (step 404). As noted above, In accordance with a feature of the present invention, sufficient historical data is collected so as to provide a realistic, fictional representation of a true player. However, the historical data is from multiple real players over periods of time such that the fictional player is not representative of any single, live player.

It will be appreciated that the type and characteristics of the historical data collected may be varied to create a desired fictional player. Such variations may include, for example:
the actual, real life players from which historical data is selected,
the quantity of data selected,
the historical period from which data is selected,
the teams, leagues and other affiliations from which historical data is selected,
the number of real life players from which historical data is selected, and
other characteristics of the historical data which will now be apparent to the reader.

Further, the aggregated data for each player may be selectively modified to vary the simulated characteristics of that player. Prowess and skill may be increased or decreased, violent tendencies may be varied, speed may be adjusted upwards or downwards, skills and characteristics may change with fictional ‘aging’ and/or injuries, and numerous other modifications made, as will now be apparent to the reader, to provide a desired fictional player. In accordance with the present invention, however, such variations and modifications as are described herein are made so as to create realistic, long-term fictional players.

Similarly to the aggregation of historical data to create a fictional player, there is selected historical team and league data for aggregation (step 406). As described below, this team and league data is used to establish groupings such as baseball teams and leagues and to simulate realistic histories and future play of those teams and leagues.

In accordance with one embodiment of the invention, variances to the true historical data may be selectively introduced into the historical player, team and league data in order to achieve particular results (step 408). In some instances, it may be desired to introduce factors of randomness in order to randomize play. In other instances, it may be desirable to introduce discreet, non-random factors into the collected data in order to induce certain non-random characteristics in the simulated play. Exemplary non-random modifications to the data may include:
the level of violence displayed in the play,
the amount of action displayed in the play,
the levels of skill displayed in the play, and
numerous other modifications as will now be apparent to the reader.

In another embodiment of the invention, different types of non-random modifications may be introduced into different sports activities for different audiences. For example, a European audience may be provided a soccer simulation with a greater degree of violence than that preferred by and thus offered to an American audience. As another example, the degree of skill in a baseball simulation may be varied for American and Japanese fans. Numerous other examples will now be apparent to the reader.

Continuing with reference to FIG. 4, the collected and selectively modified data is now assembled to form teams (step 410) and leagues (step 412).

As noted above, where equipment is relevant to the sport being simulated, the collected historical data relating to the equipment may be aggregated to create fictional equipment for the simulation in a manner analogous to the aggregation and processing of the human and team and league historical data. Such simulated equipment may be assigned to various operators and/or teams. The operation of the equipment may be modified as described to alter either randomly or fundamentally the operation of the equipment.

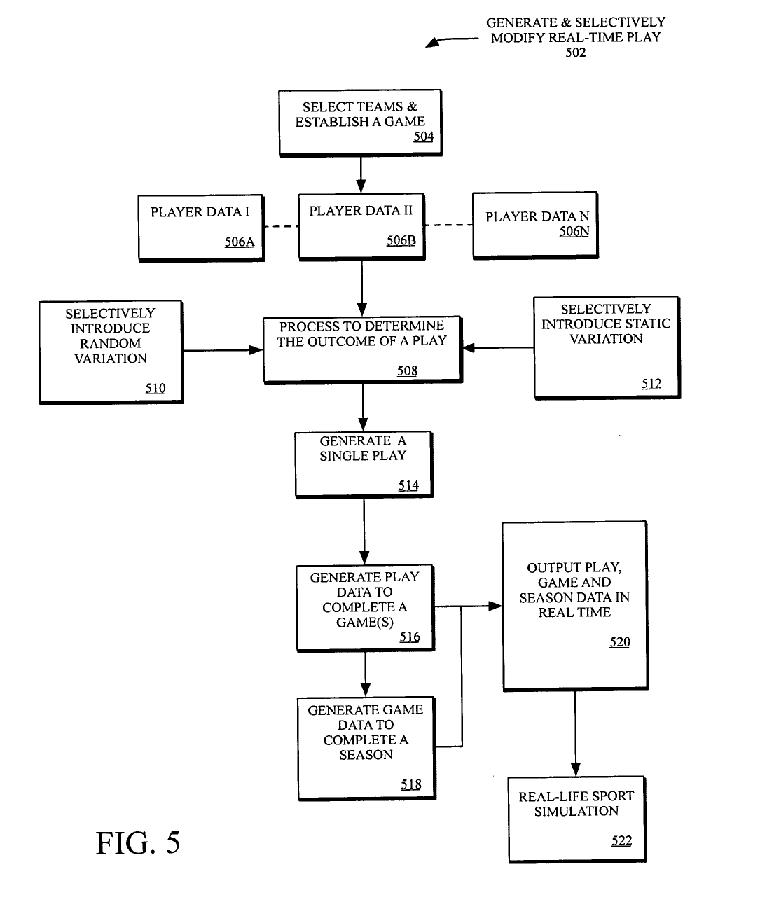

With reference now to FIG. 5, there is shown the process of generating and selectively modifying real time play (step 502) (steps 208 and 210 of FIG. 2). There are selected teams and established a game between those teams (step 504). This selection may be based upon historical data, newly created schedules, and/or a combination of both. For each play within the game, there are selected the appropriate number of fictional players 506A, B, N from the teams, the players having been previously created in accordance with the above described processes. For each play, historical data is processed to determine the outcome thereof (step 508). That is, the aggregated historical data for each player, team and league may be used in a known manner to determine a likely outcome of each particular play.

In accordance with one aspect of the invention, historically collected data is used to calculate probabilities as to the various potential outcomes of any particular play, with one outcome selected based on those probabilities to simulate the play.

In accordance with another aspect of the present invention, select random variations (step 510) and non-random variations (step 512) may be introduced into each interaction of players, where by to generate a resultant play (step 514). As described above, these variations may be introduced through modifications to the historical data, thereby affecting the probable outcome of a play. Alternatively, as shown in this FIG. 5, variations may be added through the modification of an outcome generated using the raw historical data. As noted above, random variations may be used to produce unexpected results, while non-random variations are used to effect a more predictable variation in the game. Multiple plays are generated so as to complete game (step 516) and multiple games are generated so as to complete a season (step 518).

Where the operation of equipment is simulated, the equipment data is used along with the player data at step 506 to generate an outcome. Equipment data may be similarly modified (steps 510, 512) by random and non-random variations pertinent to the features, characteristics and operation of the equipment. For example, equipment may be modified to be:
Faster or slower,
More or less powerful,
More or less prone to failure,
More or less accurate, and
Others as will now be apparent to the reader.

In addition to the above-described random and non-random variations, combinations of random and non-random variations may be used to achieve particular results. In addition to those described above, other exemplary variations that may improve viewer experiences for a sports activity can include:
For baseball, increasing the number of homeruns hit by a selected percentage.
For baseball, compressing the time to complete a game by, for example, speeding up play action.
For football, selectively introducing an increased number of ‘big’ tackles into a game.
For ice hockey, increasing scoring in a game.
For basketball, decreasing the number and/or duration of timeouts in a game.
Numerous others as will now be apparent to the reader.

In accordance with one embodiment of the present invention, play, game and season data is generated in substantially real time ( step 520) so as to simulate real life sports activities (step 522). As used to describe the present embodiment of the invention, descriptions of simulated sports activity as being in “real time” describe the generation of data substantially simultaneously with the transmission of the simulated play to fans. As described below, the consumption of the play by fans can take one or more of many forms.

It will be appreciated that the real-time generation of data, while fans are consuming it, provides many advantages. Fans have the experience of watching the play unfold in a totally life-like experience. Because the data does not exist beforehand, the simulated activities may be used as the basis for legitimate betting and gambling activities. The reader will appreciate that if the simulations are previously generated and stored prior to transmission to fans, issues of cheating might prevent gambling and betting.

In accordance with an embodiment of the invention, the simulated sports activities generated in accordance with the present invention are audited and certified as meeting the criteria for legal gambling, typically in the form of betting, in accordance with at least one state's requirements. As will be known to the reader, states with legalized gambling typically included legislation establishing the types of activity against which players may gamble and the requirements for such activities. Such states further typically have available various organizations for certifying that particular activities meet such requirements. In this embodiment of the invention, the simulation is developed, audited and certified to meet such legal requirements for betting.

However, the invention is not limited to real-time generation of data. In another embodiment, the various plays, games and seasons may be generated in accordance with the present invention and stored for future distribution to fans.

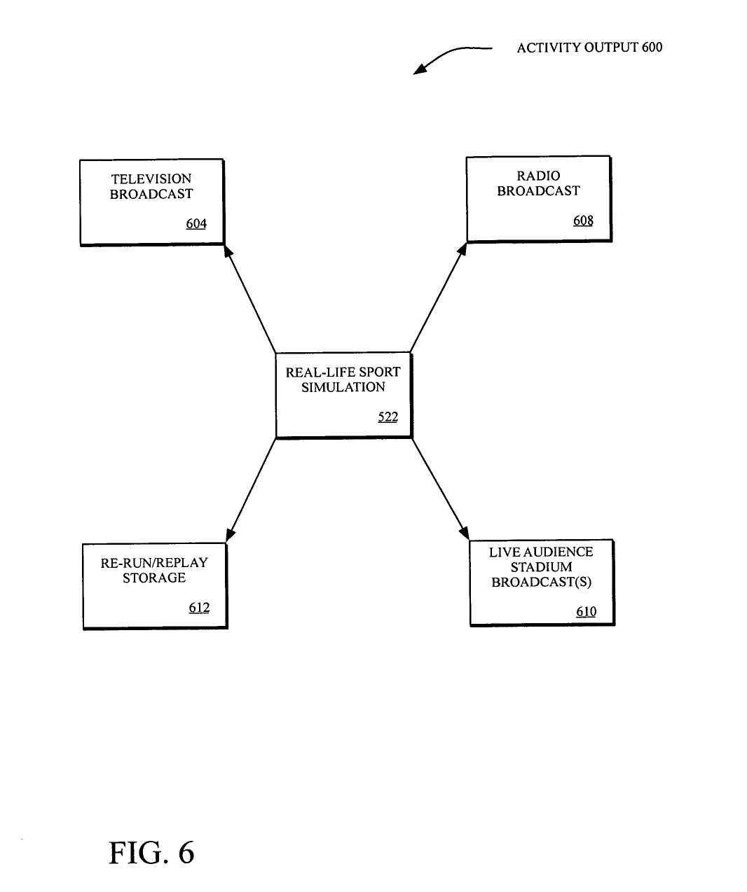

With reference now to FIG. 6, there is shown the broadcast (step 522) of a real life sports simulation, as taught and described herein above, in various human- interpretable formats. Such broadcasts may include television 604, radio 608 live stadium audience displays 610 and storage for re-runs 612. It will be understood that visual transmissions will use the simulated graphical representations of the players, plays and games as are commonly used in animated movies. In accordance with an embodiment of the invention, physical person as are created for players, play sites such as fields and other participants in, and equipment and physical materials incident to, a sports activity. As described herein, the simulations may be in real-time as generated and may be simulcast in different formats or not.

It will be appreciated that in stadiums, the events may be displayed on large-screen graphical displays of the type in common use today. Other means of communications to fans will now be apparent, for example transmission to PDAs, cellular phones, personal computers, networked video game consoles, and others. Of course, in different embodiments the simulated activities may be simulcast through different communications mediums, through only one medium or directly into storage for future transmission. Outcomes of the simulation data from system 100 may thus take one or more of many different forms of output, transmission, broadcast, etc. as is appropriate to the intended usage of the data.

There has thus been shown and described new and improved methods and systems for realistically simulating activities such as sports events. In accordance with the present invention, historical data is collected and utilized to provide life-like play, while being aggregated and modified so as to create purely fictional characters, groupings and interactions. The invention thus provides all of the entertainment value of real life sports events without requiring licenses to living players or performers. In accordance with some embodiments of the invention, random variations and/or specific, non-random variations are selectively introduced into the simulation in order to achieve particular results. The play can thus be adjusted for maximum entertainment value. The play may also be tailored to a particular style or type as preferred by a particular demographic of fans.

Further in accordance with the present invention, the simulated sports activities may be generated for large, realistic groupings of players such as teams and leagues. Life-like ‘histories’ may be developed for fictional players, teams and leagues and simulated activities may further be generated over long periods of time into the future, for example seasons. Equipment may be simulated and incorporated into the sports activity. It will be appreciated that, because of the use of real historical data and depending on the introduction of random or non-random variables into the play, the simulated play including players, teams and leagues will develop human-like, real-life characteristics over a period of time. Thus, fans will develop long-term attractions to (or dislikes of) particular players, teams and leagues. This will increase the value to the owners of the simulations and enable marketing, licensing and affiliation relationships of the simulated activities in a manner similar to the real-life activities.

Simulated activities in accordance with the present invention may be broadcast in a variety of formats, for example to television, radio and live stadium audiences. The sports simulations may be broadcast either substantially as generated or after generation and storage.

It is believed that the present invention is sufficiently realistic so as to substitute for real life sports activities. As noted above, the use of simulated activity in lieu of real life activity, in accordance with the present invention, will yield many benefits in the field of sports. Salaries of players will effectively disappear. Costs and overhead of generating sporting events will effectively drop to a minimal cost in comparison to the present situation. Costs of radio and television broadcast will drop significantly due to the ease of working with simulation data in lieu of live activities. Sports activities will become affordable to the fans and profitable to owners, sponsors and broadcasters.

The present invention has application in the fields of sports and entertainment.

While the invention has been shown and described with respect to particular embodiments, it is not thus limited. Numerous modifications, changes and improvements within the scope of the invention will now be apparent to the reader.

What is claimed is:

1. A method of simulating a sports activity on a computer, comprising:
collecting historical data relating to a sports activity;
generating, by processing the historical data, simulated player data for simulating fictional players of the sports activity;
generating, by processing the historical data, simulated play data for simulating sports plays in the sports activity including the fictional players;
generating, using the simulated player data and the simulated play data, a human-interpretable simulation of the fictional players performing the sports plays; and
outputting the human-interpretable simulation for consumption by fans.

2. The method of claim 1 wherein the step of outputting the human-interpretable simulation is performed in real time as the human-interpretable simulation is generated.

3. The method of claim 1 and further including the step of selectively introducing random variations to the human-interpretable simulation.

4. The method of claim 1 and further including the step of selectively introducing non-random variations to the human-interpretable simulation.

5. The method of claim 1 and further including:
generating, using the historical data, a fictional history for each fictional player;
generating, using the historical data, a fictional team of fictional players; and
generating, using the historical data, a fictional history for each fictional team.

6. The method of claim 5 wherein the step of generating a human-interpretable simulation includes the step of generating an entire game of the selected sports activity using the fictional players and sports plays.

7. The method of claim 6 wherein the step of generating a human-interpretable simulation includes the step of generating an entire season of the selected sports activity.

8. The method of claim 1 wherein the step of outputting the human-interpretable simulation for consumption by fans includes outputting using at least one of the group comprising a video signal broadcast, an audio signal broadcast and a visible graphical display.

9. The method of claim 1 wherein the sports activity is a team sports activity.

10. The method of claim 1 and further including the step of receiving a certification that the human-interpretable simulation meets the legal requirements for betting in at least one legal jurisdiction.

11. A system for simulating a sports activity on a computer, comprising:
a processor;
a memory connected to the processor and storing instructions to control the operation of the processor to perform the steps of:
storing historical data relating to a sports activity;
generating, by processing the historical data, simulated player data for simulating fictional players of the sports activity;
generating, by processing the historical data, simulated play data for simulating sports plays in the sports activity including the fictional players;
generating, using the simulated player data and the simulated play data, a human-interpretable simulation of the fictional players performing the sports plays; and
outputting the human-interpretable simulation for transmission to fans.

12. The system of claim 11 wherein the step of outputting the human-interpretable simulation is performed in real time as the human-interpretable simulation is generated.

13. The system of claim 11 and further including the step of selectively introducing random variations to the human-interpretable simulation.

14. The system of claim 11 and further including the step of selectively introducing non-random variations to the human-interpretable simulation.

15. The system of claim 11 and further including:
generating, using the historical data, a fictional history for each fictional player;
generating, using the historical data, a fictional team of fictional players; and
generating, using the historical data, a fictional history for each fictional team.

16. The system of claim 15 wherein the step of generating a human-interpretable simulation includes the step of generating an entire game of the selected sports activity using the fictional players and sports plays.

17. The system of claim 16 wherein the step of generating a human-interpretable simulation includes the step of generating an entire season of the selected sports activity.

18. The system of claim 11 wherein the step of outputting the human-interpretable simulation for transmission to fans includes outputting at least one of the group comprising a video signal broadcast, an audio signal broadcast and a visible graphical display.

19. The system of claim 11 wherein the sports activity is a team sports activity.

20. The system of claim 11 and further including the step of receiving a certification that the human-interpretable simulation meets the legal requirements for betting in at least one legal jurisdiction.

21. A system for simulating a sports activity on a computer, comprising:
means for collecting historical data relating to a sports activity;
means for generating, by processing the historical data, simulated player data for simulating fictional players of the sports activity;
means for generating, by processing the historical data, simulated play data for simulating sports plays in the sports activity including the fictional players;
means for generating, using the simulated player data and the simulated play data, a human-interpretable simulation of the fictional players performing the sports plays; and
means for outputting the human-interpretable simulation for consumption by fans.

22. A method operable on a computer for simulating a sports activity, comprising:
selecting a team sports activity;
collecting historical data for the team sports activity;
generating, using the historical data, a plurality of fictional teams each comprising a plurality of fictional players;
generating, using the historical data, a history for each of the fictional teams and fictional players; and
generating, using the historical data, at least one season of games amongst the fictional teams.

23. A method in accordance with claim 22 and further including the steps of:
receiving a certification that the generated games meets the legal requirements for betting in at least one legal jurisdiction; and
broadcasting the games in real-time to viewers.

24. The method of claim 22 wherein the step of generating at least one season of games includes, in addition to using the historical data, using a variation to the historical data selected from the group comprising a non-random variation and a random variation.

25. A method operable on a computer for facilitating legalized gambling activities, comprising:
selecting a team sports activity;
collecting historical data for the team sports activity;
generating, using the historical data, a plurality of fictional teams each comprising a plurality of fictional players;
generating, using the historical data, a history for each of the fictional teams and fictional players;
generating, using the historical data, at least one season of games amongst the fictional teams;
receiving a certification that the generated games meets the legal requirements for betting in at least one legal jurisdiction; and
broadcasting the generated games for betting by fans.

26. A method operable on a computer for generating cost-effective sports events, comprising:
selecting a team sports activity;
collecting historical data for the team sports activity;
generating, based upon the historical data, a plurality of entirely fictional players, each having a personal fictional history;
generating, based upon the historical data, a plurality of fictional teams each comprising selected ones of the fictional players, each of the teams having a team fictional history; and
generating, using the fictional teams with fictional players, multiple seasons of games of the team sports activity;
whereby the use of the historical data results in realistic games without obligating the payment of license fees to real-life parties.

27. A method operable on a computer for simulating a sports activity, comprising:
selecting a sports activity;
collecting historical data for the sports activity including historical data for players of the sports activity and historical data for equipment used in the sports activity;
generating, using the historical data, a plurality of fictional players each assigned at least one piece of fictional equipment; and
simulating, using the fictional payers and fictional equipment, the sports activity.
